(19) United States
(12) Patent Application Publication
(10) Pub. No.: US 2008/0048977 A1
(43) Pub. Date: Feb. 28, 2008

(54) Pointing device

(75) Inventors: Shinichiro Akieda, Shinagawa (JP); Satoshi Sakurai, Shinagawa (JP); Nobuo Yatsu, Shinagawa (JP); Takuya Uchiyama, Shinagawa (JP)

Correspondence Address: STAAS & HALSEY LLP, SUITE 700, 1201 NEW YORK AVENUE, N.W., WASHINGTON, DC, 20005, US

(73) Assignee: Fujitsu Component Limited, Tokyo (JP)

(21) Appl. No.: 11/892,402

(22) Filed: Aug. 22, 2007

(30) Foreign Application Priority Data
Aug. 22, 2006 (JP) 2006-225890

(51) Int. Cl. G06F 3/033

(52) U.S. Cl. 345/157

(57) ABSTRACT

A pointing device includes a movable member, a guide mechanism, an operation member, a press board and a switch. The guide mechanism guides the movable member in a first axis direction and in a second axis direction so that the movable member is movable, the first axis and the second axis being at right angles to each other. The operation member moves with the movable member and is movable in a pressing direction. The press board deforms elastically when engaged with the operation member being pressed. The switch having an electrical contact state is changed when the switch is pressed by the press board deformed elastically.

### BACKGROUND OF THE INVENTION

1. Field of the Invention

This invention generally relates to a pointing device that is applied to an electronic device such as a personal computer, a vehicle, a game machine, a mobile terminal, or a television.

2. Description of the Related Art

Japanese Patent Application Publication No. 2001-255995, No. 2000-311052, No. 2003-178653, No. 2004-62447, No. 2001-331267 and No. 2006-153670 disclose a pointing device that may move a point in a two dimensional plane and another pointing device that has a select switch selecting a moved point.

It is demanded that the pointing device is downsized, has high resistance and operability and has a high accuracy of determining a point, in a case where the pointing device is applied to an electronic device.

There is a problem that one of the pointing devices having a movable operation portion has a low accuracy of determining a point because of a rattle that is generated when the operation portion is guided with a guide groove.

And, there is a problem that resistance is degraded when a switch for selecting a point is structured with a sliding contact point.

Further, it is necessary to draw a wire and it is difficult to downsize the pointing device if a switch for selecting a point is provided on a movable operation portion.

### SUMMARY OF THE INVENTION

The present invention provides a pointing device that is downsized, has high resistance and operability and has a high accuracy of determining a point.

According to an aspect of the present invention, preferably, there is provided a pointing device including a movable member, a guide mechanism, an operation member, a press board and a switch. The guide mechanism guides the movable member in a first axis direction and in a second axis direction so that the movable member is movable, the first axis and the second axis being at right angles to each other. The operation member moves with the movable member and is movable in a pressing direction. The press board deforms elastically when engaged with the operation member being pressed. The switch having an electrical contact state is changed when the switch is pressed by the press board deformed elastically.

With the above-mentioned structure, the operation member moves to the movable member in the pressing direction and is engaged with the press board, when the position of the operation member is determined desirably on a plane demarked with the first axis and the second axis and the operation member is operated and is pressed. In this case, an electrical contact state of the switch is changed, when the press board is elastically deformed and the press board presses the switch. The position appointed with the operation member is therefore determined in the plane.

### BRIEF DESCRIPTION OF THE DRAWINGS

Preferred embodiments of the present invention will be described in detail with reference to the following drawings, wherein:

FIG. 1 illustrates an external perspective view of a pointing device in accordance with an embodiment of the present invention;

FIG. 2 illustrates a top view of the pointing device;

FIG. 3 illustrates a cross sectional view taken along a line A-A in FIG. 2;

FIG. 4 illustrates a perspective exploded view of the pointing device;

FIG. 5A and FIG. 5B illustrate a cross sectional view showing an operation of the pointing device;

FIG. 6 illustrates a perspective view of an operation member, a press board and a support member of a pointing device in accordance with another embodiment of the present invention;

FIG. 7 illustrates a cross sectional view of the pointing device;

FIG. 8 illustrates a perspective view of a support member and a press board of a pointing device in accordance with another embodiment of the present invention;

FIG. 9A illustrates a top view of the support member and the press board;

FIG. 9B illustrates a bottom view of the support portion and the press board;

FIG. 10 illustrates a cross sectional view of the support member and the press board;

FIG. 11A and FIG. 11B illustrate a cross sectional view for describing an operation of the pointing device.

### DESCRIPTION OF THE PREFERRED EMBODIMENTS

A description will now be given, with reference to the accompanying drawings, of embodiments of the present invention.

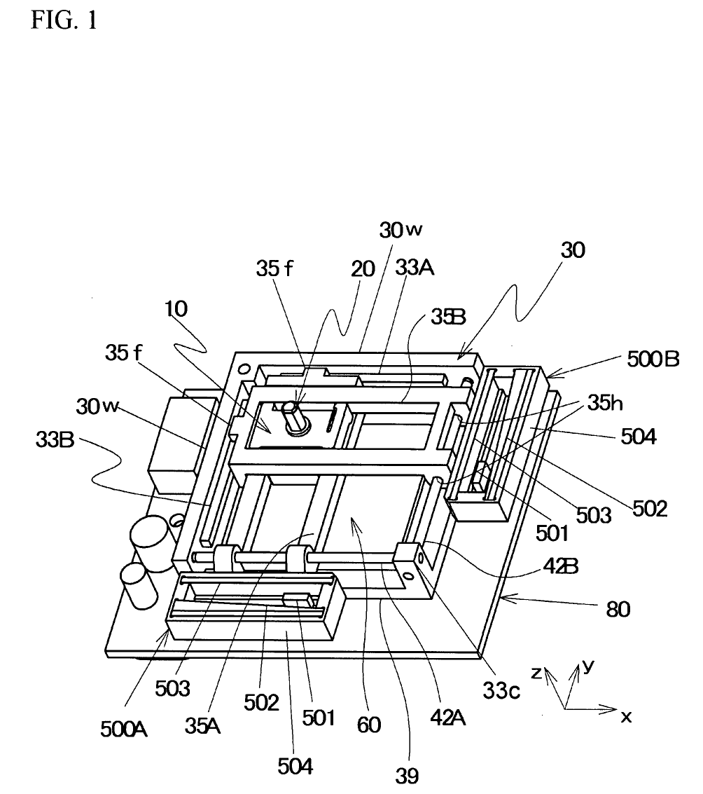

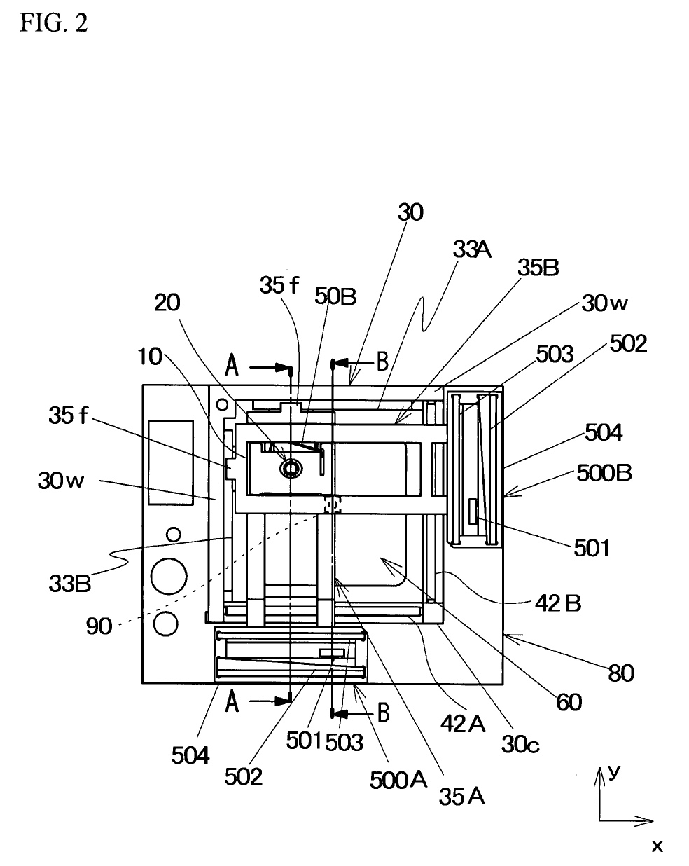

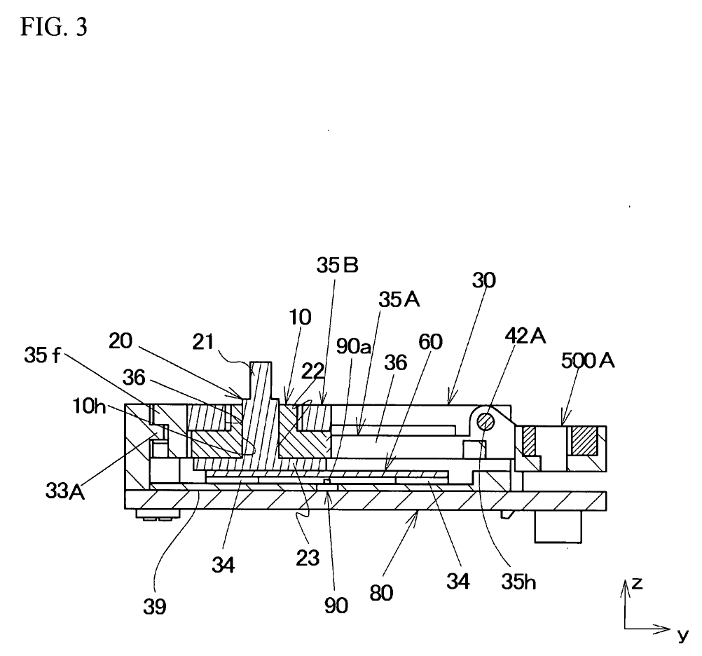

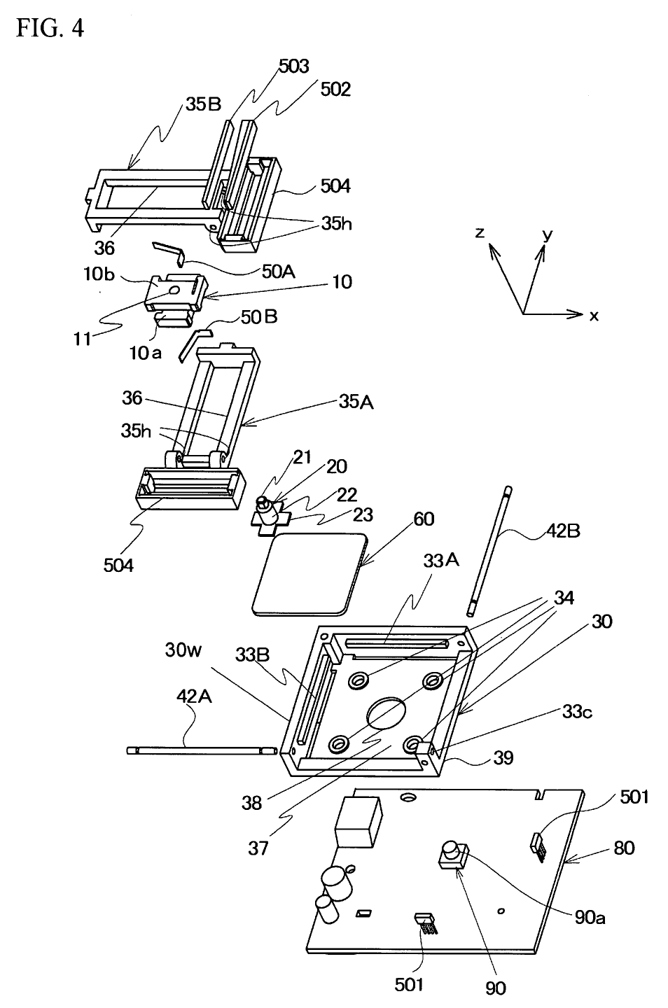

FIG. 1 through FIG. 4 illustrate a pointing device in accordance with an embodiment of the present invention. FIG. 1 illustrates an external perspective view of the pointing device. FIG. 2 illustrates a top view of the pointing device. FIG. 3 illustrates a cross sectional view taken along a line A-A in FIG. 2. FIG. 4 illustrates a perspective exploded view of the pointing device.

As shown in FIG. 1 through FIG. 4, the pointing device has a movable member 10, an operation member 20, a support member 30, an x-axis slider 35A, a y-axis slider 35B, a guide rods 42A and 42B, a board springs 50A and 50B acting as a first biasing member and a second biasing member, a press board 60 supported by the support member 30, a substrate 80 having an electronic device mounted thereon and fixing the support member 30 on a main surface thereof, position detectors 500A and 500B, a switch 90 mounted on the substrate 80, and so on. A guide mechanism is composed of the support member 30, the guide rods 42A and 42B, the x-axis slider 35A, the y-axis slider 35B, and so on.

The movable member 10 is made of a resin material. As shown in FIG. 4, the movable member 10 has a bottom portion 10a, a top portion 10b, a guide hole 11 and so on. The bottom portion 10a may be fitted into a guide groove 36 mentioned later of the x-axis slider 35A. The top portion 10b may be fitted into a guide groove 36 mentioned later of the y-axis slider 35B. The guide hole 11 is formed along a z-direction as a pressing direction and passes through the bottom portion 10a and the top portion 10b.

A shaft 22 mentioned later of the operation member 20 is fitted into the guide hole 11. The guide hole 11 guides the operation member 20 in the z-axis direction (the pressing direction) so that the operation member 20 is movable. And the guide hole 11 has a cross section having a noncircular shape such as an ellipse shape.

The operation member 20 is used for a pointing operation on a plane formed with the x-axis and the y-axis and for a pressing operation selecting (determining) a pointed position. As shown in FIG. 1, FIG. 4 and so on, the operation member 20 has a projection portion 21, the shaft 22, a sliding portion 23 and so on. The projection portion 21 projects from a top face of the movable member 10. The shaft 22 may be fitted into the guide hole 11 of the movable member 10. The sliding portion 23 is formed in a flange shape on an end portion of the shaft 22 and slides on the press board 60.

A contact area between the sliding portion 23 and the press board 60 is enlarged because the sliding portion 23 has a flange shape. Therefore, a pressing force is conducted to the press board 60 stably, when the operation member 20 is pressed.

A cross section of the shaft 22 is formed so as to correspond to that of the guide hole 11 of the movable member 10. A revolution of the operation member 20 is limited around the shaft 22, and the operation member 20 is therefore capable of conducting the press force to the press board 60 stably.

The support member 30 is, for example, formed integrally with a resin. As shown in FIG. 4 and so on, the support member 30 has a rectangular outer shape, and has a plate-shaped base face 37, a peripheral wall portion 30w, a columnar support portion 33c, support rails 33A and 33B, an opening 38, four projecting support portions 34, a bottom face 39 and so on. The peripheral wall portion 30w projects from two adjacent sides of a peripheral portion of the base face 37. The columnar support portion 33c projects from a corner of the base face 37 so as to face with the peripheral wall portion 30w. The support rails 33A and 33B are respectively formed integrally in an inner wall of the peripheral wall portion 30w. The opening 38 has a circular shape and is formed at a center portion of the base face 37. The projecting support portions 34 project from four positions that are symmetrical with respect to a center axis of the opening 38 and are positioned on the base face 37. The bottom face 39 is to be arranged on the substrate 80.

The projecting support portions 34 support the four corners of the bottom face of the press board 60 so that the press board 60 is bended (elastically deformed) when the press board 60 is pressed by the sliding portion 23 of the operation member 20.

The opening 38 is formed so that the elastically deformed press board 60 is engaged with (contacts with) the switch 90 mounted on the substrate 80 and is pressed with the switch 90.

The guide rods 42A and 42B are, for example, made of a material such as a metal or a resin. As shown in FIG. 1, FIG. 2 and FIG. 4, each first end of the guide rods 42A and 42B is inserted in the through hole formed in the peripheral wall portion 30w of the support member 30 and is supported, and each second end of the guide rods 42A and 42B is inserted in the through hole formed in the columnar support portion 33c of the support member 30 and is supported. The guide rods 42A and 42B are respectively inserted in each through hole 35h formed in the x-axis slider 35A and the y-axis slider 35B respectively and may guide the x-axis slider 35A and y-axis slider 35B in the x-axis (a first axis) direction and in the y-axis (a second axis) direction so that the x-axis slider 35A and the y-axis slider 35B are movable.

The x-axis slider 35A is made of resin or the like. As shown in FIG. 1, FIG. 2 and FIG. 4, the x-axis slider 35A has the guide groove 36, the through hole 35h, an engagement projection 35f and so on. The guide groove 36 guides the movable member 10 in the y-axis direction. The through hole 35h is formed at two positions at a first end of the x-axis slider 35A on a same axis. The guide rod 42A is inserted in the through hole 35h. The engagement projection 35f projects from a second end of the x-axis slider 35A, is engaged with the support rail 33A of the support member 30, and slides on the support rail 33A.

The y-axis slider 35B is made of a resin or the like and is formed in the same shape as the x-axis slider 35A. As shown in FIG. 1, FIG. 2 and FIG. 4, the y-axis slider 35B has the guide groove 36, the through hole 35h, the engagement projection 35f and so on. The guide groove 36 guides the movable member 10 in the x-direction. The through hole 35h is formed at two positions at a first end of the y-axis slider 35B on a same axis. The guide rod 42B is inserted in the through hole 35h. The engagement projection 35f projects from a second end of the y-axis slider 35B, is engaged with the support rail 33B of the support member 30, and slides on the support rail 33B.

The board springs 50A and 50B are made of a steal or the like. As shown in FIG. 4, the board springs 50A and 50B are bended at mid-position in a longer direction thereof. A first end of the board spring 50A is inserted in an insert portion formed in the bottom portion 10a of the movable member 10. A first end of the board spring 50B is inserted in an insert portion formed in the top portion 10b. Thus the board springs 50A and 50B are cantilevered. The board springs 50A and 50B biases the movable member 10 in one direction along the x-axis and in one direction along the y-axis any time by pressing a side face of the guide groove 36, with the bottom portion 10a and the top portion 10b of the movable member 10 being inserted in each of the guide grooves 36 of the x-axis slider 35A and the y-axis slider 35B. Therefore, a rattle of the movable member 10 inserted in each of the guide grooves 36 is absorbed.

The press board 60 is made of a resin or the like. As shown in FIG. 4, the press board 60 is a board material having a rectangular exterior. The press board 60 supports the sliding portion 23 of the operation member 20 so that the sliding portion 23 is slidable, is elastically deformed by a press force from the sliding portion 23 of the operation member 20, and presses a movable portion 90a of the switch 90 facing with the press board 60.

The substrate 80 is, for example, a printed wiring substrate. As shown in FIG. 4, the substrate 80 has a rectangular exterior. The switch mentioned later is mounted at a substantially center portion of a main surface of the substrate 80. Two electromagnetic conversion elements 501 are mounted around the center portion of the main surface. Other electronic devices are mounted on the main surface of the substrate 80.

As shown in FIG. 3, FIG. 4 and so on, the switch 90 is fixed to the substrate 80, and has the movable portion 90a on an upper portion thereof. The movable portion 90a is biased upward by an elastic member such as a spring not shown. When the movable portion 90a is pressed, the movable portion 90a gets into a main body and an electric contact condition of the switch 90 is changed. For example, the electrical state of the switch 90 is off when the movable portion 90a is projecting. The electrical state of the switch 90 is on when the movable portion 90a is pressed.

The position detectors 500A and 500B are composed of the electromagnetic conversion element 501, a permanent magnet 502, a yoke 503, and holders 504 fixed to the x-axis slider 35A and the y-axis slider 35B respectively. A detail structure of the position detectors 500A and 500B is disclosed in Japanese Patent Application Publication No. 2006-153670.

As shown in FIG. 1, FIG. 2 and FIG. 4, each of the electromagnetic conversion elements 501 is mounted on a given position of the substrate 80 respectively, and inserted in the holders 504.

As shown in FIG. 1 and FIG. 4, each of the holders 504 is coupled to a first end of the x-axis slider 35A and to a first end of the y-axis slider 35B, and holds the permanent magnet 502 and the yoke 503 so that the permanent magnet 502 and the yoke 503 face with each other.

The permanent magnet 502 is, for example, formed in a wedge shape. A distance between the permanent magnet 502 and the electromagnetic conversion element 501 is changed when the x-axis slider 35A and the y-axis slider 35B are moved. When the distance is changed, a magnetic flux density detected by the electromagnetic conversion element 501 is changed and an electric signal from the electromagnetic conversion element 501 is changed. The output of the electromagnetic conversion element 501 is changed according to the positions of the x-axis slider 35A and the y-axis slider 35B. It is therefore possible to detect the position of the operation member 20 in the x-axis direction and the y-axis direction.

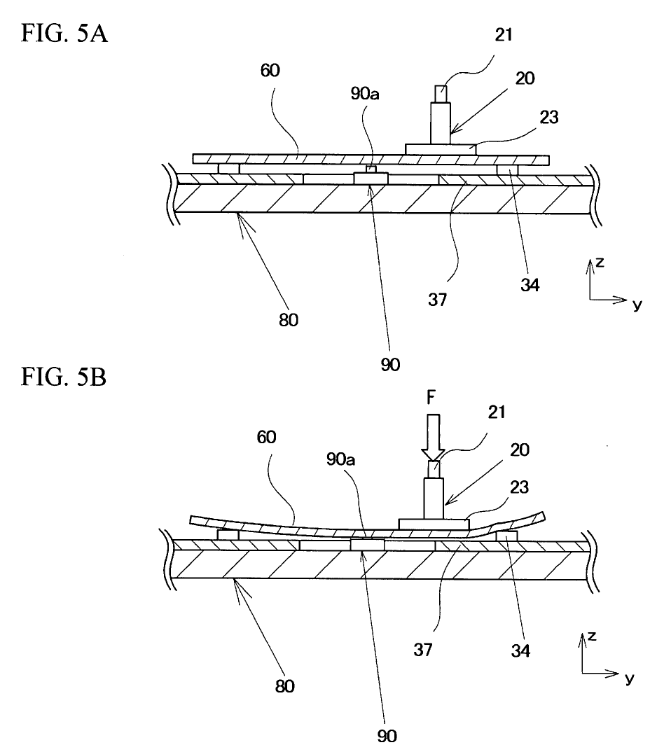

Next, a description will be given of an operation of the above-mentioned pointing device during the pressing operation, with reference to FIG. 5A and FIG. 5B. FIG. 5A and FIG. 5B illustrate a cross sectional view of a main structure taken along a line B-B in FIG. 2.

As shown in FIG. 5A, the operation member 20 moves on the press board 60 with the movable member 10 by an pointing operation of a user, and the operation member 20 gets to a position the user desires. In this case, the position of the movable member 10 is determined accurately on a plane demarked with the x-axis and the y-axis, because the movable member 10 is biased by the board springs 50A and SOB in one direction along the x-axis and in one direction along the y-axis and the rattle is eliminated.

And the press board 60 is not deformed and the press board 60 and the movable portion 90a of the switch 90 are separated from each other, when the operation member 20 is not operated (pressed down).

As shown in FIG. 5B, when a press force F is added to the operation member 20 with the operation of the user, the operation member 20 is guided by the guide hole 11 of the movable member 10 (not shown) in the z-axis direction (pressing direction) and presses the press board 60 with the sliding portion 23. Thus, the press board 60 is bended and presses the movable portion 90a of the switch 90. As a result, the electrical contact state of the switch 90 is changed and the user can select a desirable point.

In accordance with the embodiment, the switch 90 has a resistance much higher than that of a switch using a sliding contact point, because the switch 90 is of a press type. And a wiring is not necessary because it is not necessary to connect the operation member 20 and the switch electrically. Further, the operability is high during the operation with a finger, because a sliding resistance is very small between the press board 60 and the sliding portion 23 of the operation member 20 when the operation member 20 is not pressed.

In addition, in accordance with the embodiment, a description is given of the structure in which the sliding portion 23 of the operation member 20 is contacting to the press board 60 in any time. However, it is not limited to the structure. For example, the sliding portion 23 may be biased upward by an elastic member such as a spring, the sliding portion 23 of the operation member 20 and the press board 60 may be separated from each other, and the operation member 20 may be engaged with the press board 60 only when a press force by a user is added thereto.

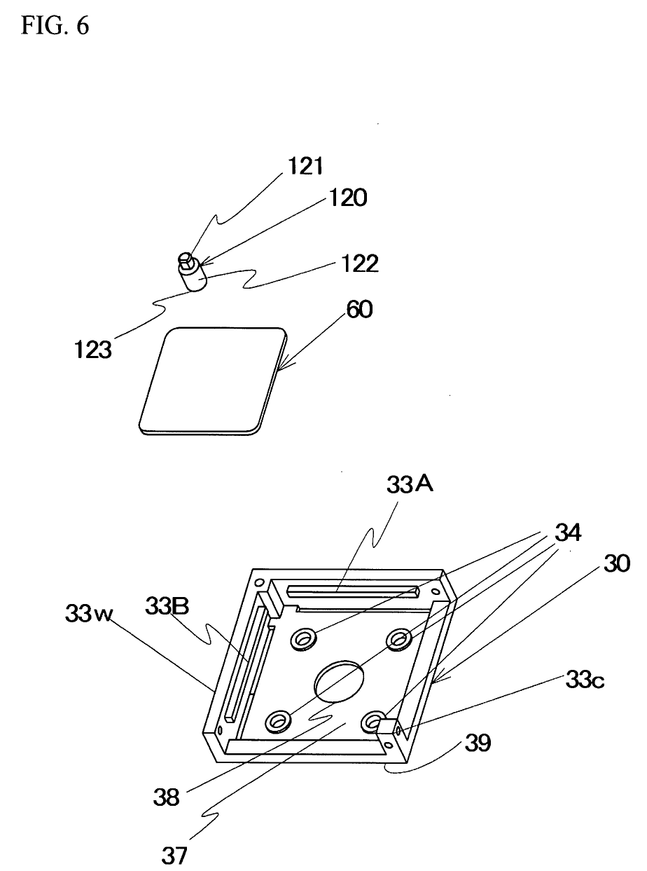

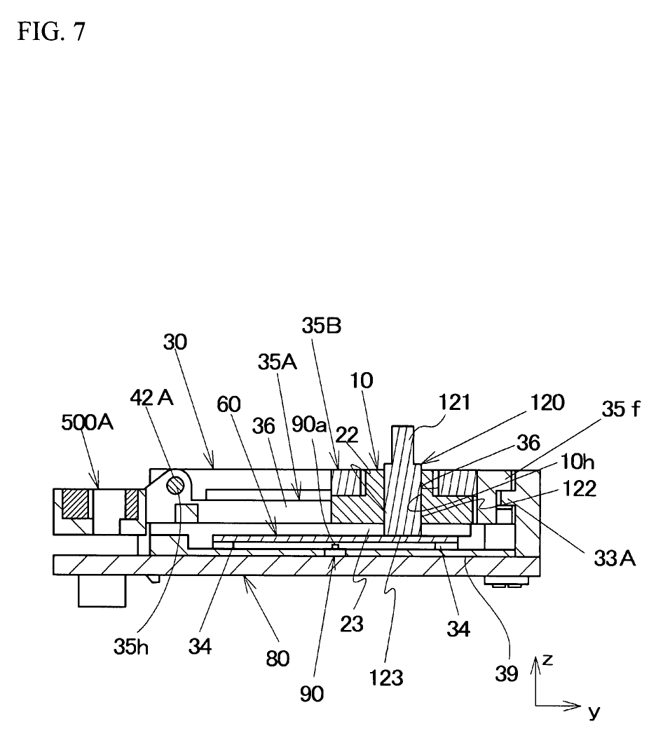

FIG. 6 and FIG. 7 illustrate another embodiment in accordance with the present invention. FIG. 6 illustrates a perspective view of an operation member, a press board and a support member. FIG. 7 illustrates a cross sectional view of a main structure of a pointing device. The same components have the same reference numerals in order to avoid a duplicated explanation.

In the pointing device in accordance with this embodiment, a structure of an operation member 120 is different from the above-mentioned embodiment. The other structure is the same as the above-mentioned embodiment.

The operation member 120 has a projection portion 121, a shaft 122, and a sliding portion 123 that is provided on an end face of the shaft 122 and slides on the press board 60. That is, the operation member 120 does not have the above-mentioned sliding portion having a guard shape. A high operability is obtained when an area of the sliding portion 123 or a diameter of the shaft 122 is adjusted adequately, even if the structure is adopted.

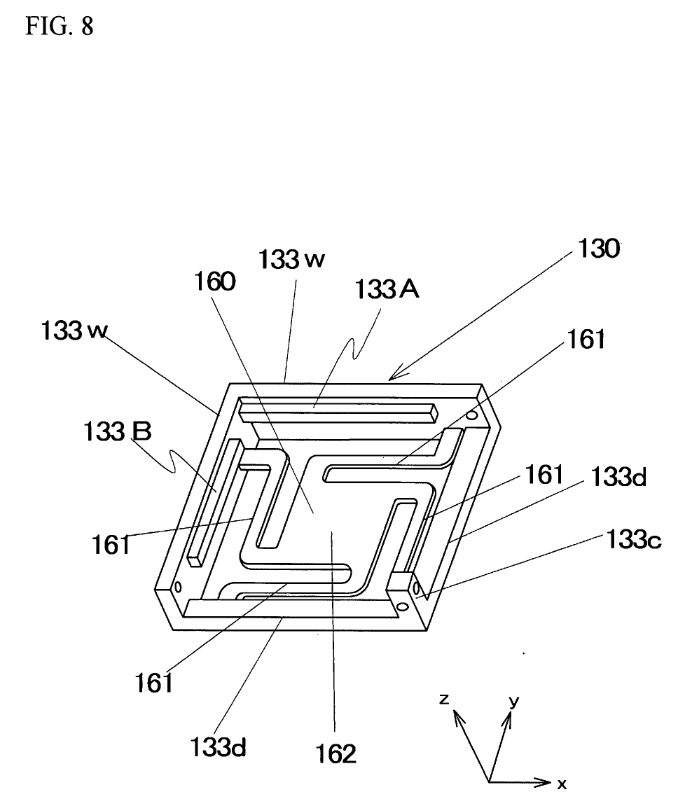

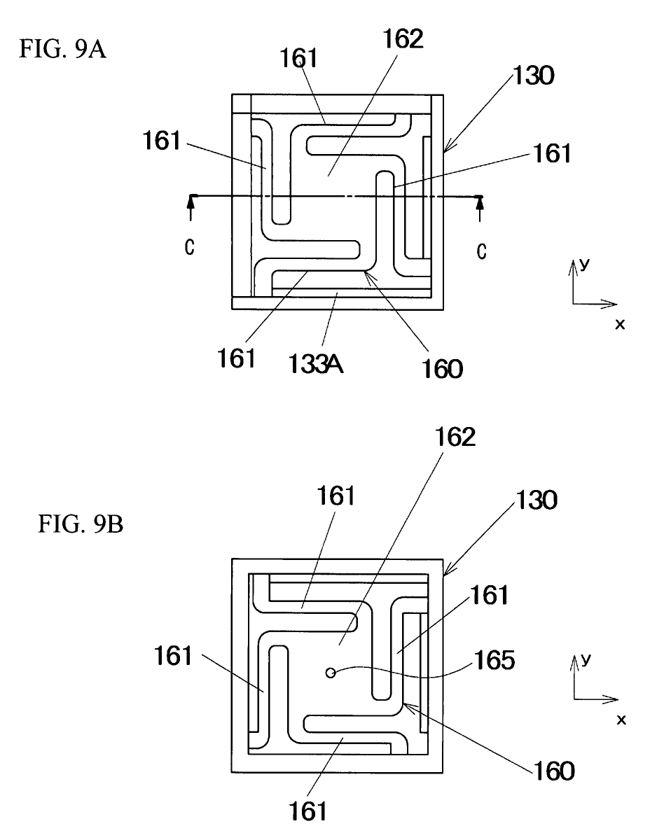

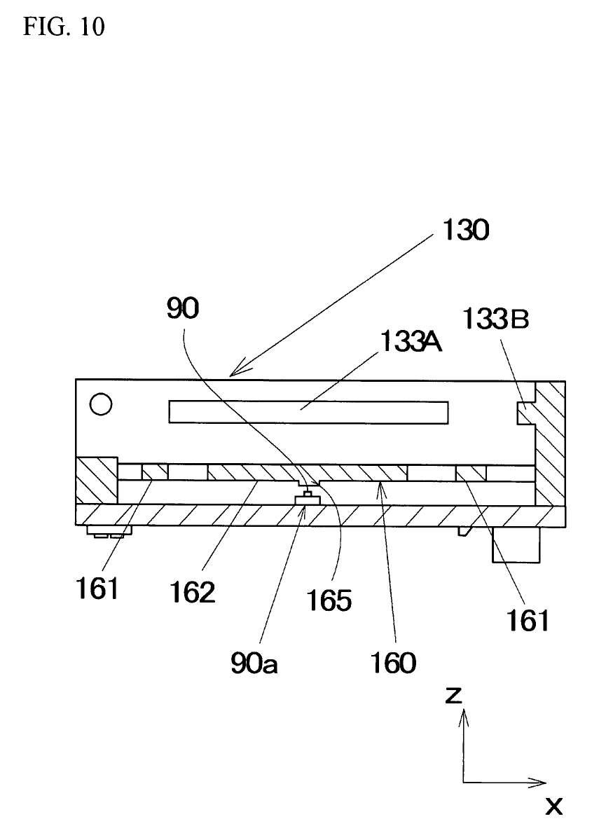

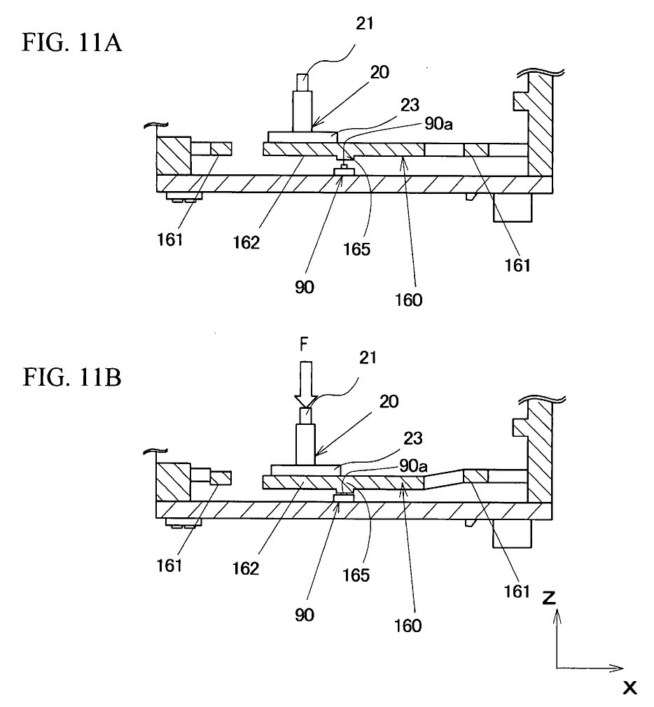

FIG. 8 through FIG. 11B illustrate a pointing device in accordance with another embodiment of the present invention. FIG. 8 illustrates a perspective external view of a support member and a press board. FIG. 9A and FIG. 9B illustrate respectively a top view and a bottom view of a support portion and the press board. FIG. 10 illustrates a cross sectional view taken along a line C-C of FIG. 9A. FIG. 11A and FIG. 11B illustrate a cross sectional view for describing an operation of the pointing device. In FIG. 8 through FIG. 11B, the same components have the same reference numerals in order to avoid a duplicated explanation. In the pointing device in accordance with this embodiment, a structure of the support member and the press board are different from the above-mentioned embodiment. The other structure is the same as the above-mentioned embodiment.

As shown in FIG. 8, a support member 130 has a rectangular exterior and is formed integrally with a material such as a resin. The support member 130 has two peripheral wall portions 133w, a columnar support portion 133c facing with the peripheral wall portions 133w, a coupling portion 133d coupling the columnar support portion 133c and each end of the peripheral wall portions 133w, support rails 133A and 133B and so on. The peripheral wall portions 133w are formed at two sides of the support member 130 adjacent to each other. The support rails 133A and 133B are respectively formed integrally in an inner wall of the peripheral wall portions 133w.

The support rails 133A and 133B support the engagement projections 35f formed on the x-axis slider 35A and the y-axis slider 35B respectively so that the engagement projections 35f may slide. The peripheral wall portions 133w and the columnar support portion 133c support both ends of the above-mentioned guide rods 42A and 42B.

A press board 160 is made of a material such as a resin and is formed integrally on the support member 130. As shown in FIG. 8 through FIG. 10, the press board 160 has a press portion 162 having a substantially rectangular shape, four coupling beams 161, and an engagement projection 165. The coupling beams 161 extend from each of the corners of the press portion 162. Each end portion of the coupling beams 161 is coupled to and supported by the peripheral wall portion 133w or the coupling portion 133d. The engagement projection 165 is provided on the side of the lower face of the support member 130 facing with the switch 90, and is engaged with the movable portion 90a of the switch 90.

The coupling beam 161 has stiffness lower than that of the press portion 162. The coupling beam 161 is bended when the press portion 162 is subjected to a press force. The press portion 162 moves in the pressing direction when the coupling beam 161 is bended.

Next, a description will be given of an operation during the pressing operation of the pointing device mentioned above, with reference to FIG. 11A and FIG. 11B. FIG. 11A and FIG. 11B illustrate a cross sectional view of a main structure taken along a line C-C of FIG. 9A.

As shown in FIG. 11A, the engagement projection 165 of the press board 160 is separated from the movable portion 90a of the switch 90 when the operation member 20 is not operated (pressed down).

As shown in FIG. 11B, the operation member 20 is guided by the guide hole 11 of the movable member 10 (not shown) in the z-axis direction (pressing direction) and presses the press portion 162 of the press board 160 with the sliding portion 23, when the press force F is added to the operation member 20 with the operation of the user. Thus each of the coupling beams 161 is bended, and the whole of the press portion 162 moves downward. And the engagement projection 165 of the press portion 162 presses the movable portion 90a of the switch 90, and the electrical contact state of the switch 90 is changed. As a result, the user can select a desirable point.

In accordance with the embodiment, the switch 90 is pressed more accurately, because the elastically deformable coupling beam 161 is formed on the press board 160 and the coupling beam 161 is mainly bended elastically when a press force is added.

And in accordance with the embodiment, it is possible to reduce an assembling process and a manufacturing cost.

In addition, the support member 130 and the press board 160 may be formed integrally with an injecting formation. However, the support member 130 and the press board 160 may be formed by coupling a multiple of components with an adhesive agent or the like.

In the above-mentioned embodiment, the board spring 50A acts as the first biasing member and the board spring 50B acts as the second biasing member. Another biasing member may be applied to the present invention.

While the above description constitutes the preferred embodiments of the present invention, it will be appreciated that the invention is susceptible of modification, variation and change without departing from the proper scope and fair meaning of the accompanying claims.

The present invention is based on Japanese Patent Application No. 2006-225890 filed on Aug. 22, 2006, the entire disclosure of which is hereby incorporated by reference.

What is claimed is:

1. A pointing device comprising:
a movable member;
a guide mechanism that guides the movable member in a first axis direction and in a second axis direction so that the movable member is movable, the first axis and the second axis being at right angles to each other;
an operation member that moves with the movable member and is movable in a pressing direction;
a press board that deforms elastically when engaged with the operation member being pressed; and
a switch having an electrical contact state that is changed when the switch is pressed by the press board deformed elastically.

2. The pointing device as claimed in claim 1 further comprising a first biasing member and a second biasing member that bias the movable member in one direction along the first axis and in one direction along the second axis respectively in order to restrict a rattle of the movable member in the first axis direction and in the second axis direction with respect to the guide mechanism.

3. The pointing device as claimed in claim 1, wherein:
the guide mechanism has a first slider and a second slider, the first slider being guided and movable in the first axis direction and having a guide groove guiding the movable member in the second axis direction, the second slider being guided and movable in the second axis direction and having a guide groove guiding the movable member in the first axis direction;
the first biasing member biases the movable member in one direction along the first axis; and
the second biasing member biases the movable member in one direction along the second axis.

4. The pointing device as claimed in claim 1, wherein the operation member has a shaft fitted into a guide hole formed in the movable member along the pressing direction.

5. The pointing device as claimed in claim 4, wherein the operation member has a sliding portion that is provided on an end of the shaft, has a guard shape and slides on the press board.

6. The pointing device as claimed in claim 1, wherein the press board is supported by a plurality of projecting support portions formed on a given base face so as to be elastically deformable.

7. The pointing device as claimed in claim 1, wherein the press board has a sliding portion on which the operation member slides and has a coupling beam that has a beam shape so as to be elastically deformable and couples the sliding portion to a support member supporting the first and the second sliders.

8. The pointing device as claimed in claim 1, wherein the switch is mounted on a substrate arranged along a plane including the first axis and the second axis.

9. The pointing device as claimed in claim 8, wherein the support member is provided on the substrate.

10. The pointing device as claimed in claim 1, wherein the press board has an engagement projection engaged with the switch on a face facing with the switch.

11. The pointing device as claimed in claim 2, wherein the first biasing member and the second biasing member include a board spring arranged between the movable member and the guide groove.

12. The pointing device as claimed in claim 4, wherein a revolution of the operation member around the shaft is restricted by the fitting of the operation member into the movable member.
